(19) United States
(12) Patent Application Publication
(10) Pub. No.: US 2026/0045733 A1
(43) Pub. Date: Feb. 12, 2026

(54) Connector

(71) Applicant: Yazaki Corporation, Tokyo (JP)

(72) Inventors: Yuuhei Takeshita, Makinohara-shi (JP); Koki Iwakura, Makinohara-shi (JP); Yasuo Shimizu, Makinohara-shi (JP); Toshikazu Yoshioka, Makinohara-shi (JP); Moeto Osawa, Fujieda-shi (JP)

(21) Appl. No.: 19/291,855

(22) Filed: Aug. 6, 2025

(30) Foreign Application Priority Data
Aug. 7, 2024 (JP) 2024-130774

(51) Int. Cl. H01R 13/533; H01R 13/502

(52) U.S. Cl. CPC H01R 13/533; H01R 13/502; H01R 2201/26

(57) ABSTRACT

A connector includes a housing, a shell, and a holder. The housing has a terminal support that supports a terminal, and an electric wire accommodator through which the electric wire connected to the terminal passes. The shell is fitted on an outer side of the electric wire accommodator from an opposite side of the terminal support. The holder holds the electric wire and is fitted in an inner side of the electric wire accommodator. The electric wire accommodator includes a press-fitter that is press-fitted between the shell and the holder.

### BACKGROUND OF THE INVENTION

### Field of the Invention

The embodiments of the present invention relate to a connector.

The present application claims priority based on Japanese Patent Application No. 2024-130774 filed in Japan on Aug. 7, 2024, the contents of which are incorporated herein by reference.

### Description of Related Art

Connectors include a housing that holds a terminal connected to an electric wire, and a holder that holds the electric wire and is assembled to the housing.

### PRIOR ART DOCUMENT

### Patent Document

Patent Document 1: Japanese Unexamined Patent Application, First Publication No. 2008-140572

Patent Document 2: Japanese Unexamined Patent Application, First Publication No. 2024-047725

### SUMMARY OF THE INVENTION

Incidentally, in connectors in the related art, it is desired to suppress transmission of vibration from an electric wire to a terminal.

An embodiment is configured to provide a connector capable of suppressing transmission of vibration from an electric wire to a terminal.

A connector according to an embodiment includes a housing, a shell, and a holder. The housing has a terminal support that supports a terminal, and an electric wire accommodator through which the electric wire connected to the terminal passes. The shell is fitted on an outer side of the electric wire accommodator from an opposite side of the terminal support. The holder holds the electric wire and is fitted in an inner side of the electric wire accommodator. The electric wire accommodator includes a press-fitter that is press-fitted between the shell and the holder.

According to one embodiment, it is possible to suppress transmission of vibration from the electric wire to the terminal.

### BRIEF DESCRIPTION OF THE DRAWINGS

FIG. 1 is a perspective view illustrating a connector 1 of an embodiment.

FIG. 2 is an exploded perspective view illustrating the connector 1 of the embodiment.

FIG. 3 is a plan view illustrating the connector 1 of the embodiment.

FIG. 4 is a cross-sectional view illustrating the connector 1 of the embodiment.

FIG. 5 is a perspective view illustrating a housing 10 of the embodiment.

FIG. 6 is a cross-sectional view taken along line VI-VI in FIG. 3.

FIG. 7 is a perspective view illustrating a rear holder 60 of the embodiment.

FIG. 8 is a cross-sectional view taken along line VIII-VIII in FIG. 3.

FIG. 9 is a cross-sectional view taken along line IX-IX in FIG. 3.

FIG. 10 is an enlarged view of portion X in FIG. 9.

FIG. 11 is an enlarged view of portion XI in FIG. 4.

### DETAILED DESCRIPTION OF THE INVENTION

Hereinafter, embodiments will be described with reference to the drawings. In the following description, constitutions having the same or similar functions are denoted by the same reference numbers.

In the present application, terms are defined as follows. The term “connection” is not limited to a mechanical connection and may include an electrical connection. That is, “connection” is not limited to a case where two elements which are connection targets are directly connected, and may include a case where two elements which are connection targets are connected with another element interposed therebetween. The term “to restrict” is not limited to a case where two members are in constant contact with each other, thereby restricting movement of one member with respect to the other member.

The term “to restrict” may include, for example, a case where two members are not in contact with each other in a state in which no positional shift occurs, but the two members are brought into contact with each other when one of the two members is caused to be shifted with respect to the other, thereby restricting movement of one of the two members with respect to the other. In addition, “to restrict” means that movement in at least one direction is restricted.

Hereinafter, a right-handed XYZ coordinate system illustrated in each drawing is defined. An X direction, a Y direction, and a Z direction are defined as follows. The X direction is a fitting direction of a connector 1 in a mating connector. A +X direction is a direction from the connector 1 to the mating connector. The Y direction is a direction intersecting (in the present embodiment, a direction orthogonal to) the X direction and is a direction in which terminals 40 to be described below are arranged.

The Z direction is a direction intersecting (in the present embodiment, a direction orthogonal to) the X direction and the Y direction. Note that the X direction is an example of a “first direction”. In addition, hereinafter, for convenience of description, the +X direction may be referred to as a “front side”, and a −X direction may be referred to as a “rear side”.

### Embodiments

The connector 1 of an embodiment is a connection component for electrically connecting an electric wire 41 and a terminal fitting provided in a mating connector (not illustrated). Regarding the connector 1, for example, the connector 1 is used for a vehicle such as an electric vehicle (EV), a hybrid electric vehicle (HEV), or a plug-in hybrid electric vehicle (PHEV). The connector 1 is, for example, a high-voltage connector in which a current of 100 V or higher flows. However, the connector 1 may be a low-voltage connector. Regarding the connector 1 in the present embodiment, the connector 1 corresponds to three electrodes. However, regarding the connector 1, the connector 1 may correspond to two or less electrodes, or the connector 1 may correspond to four or more electrodes.

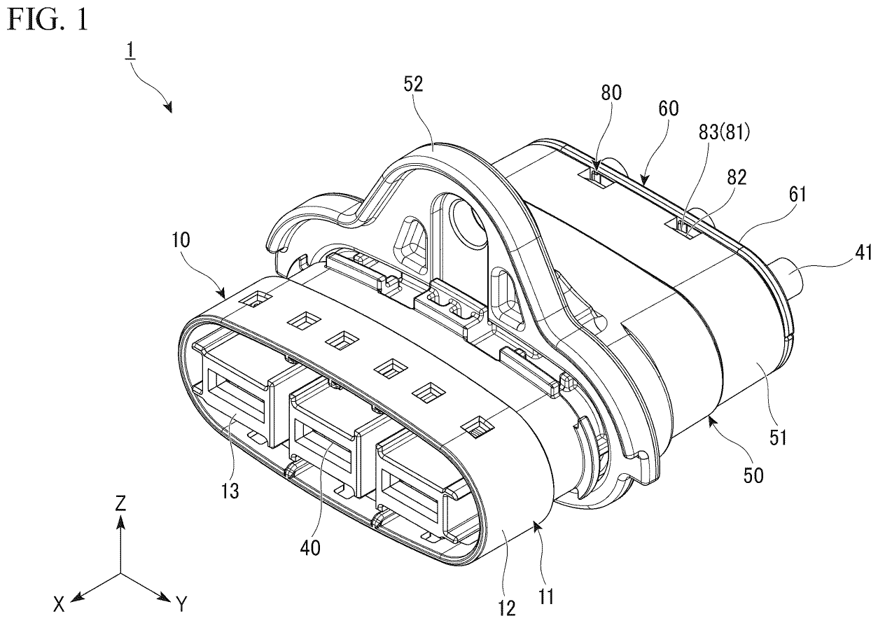

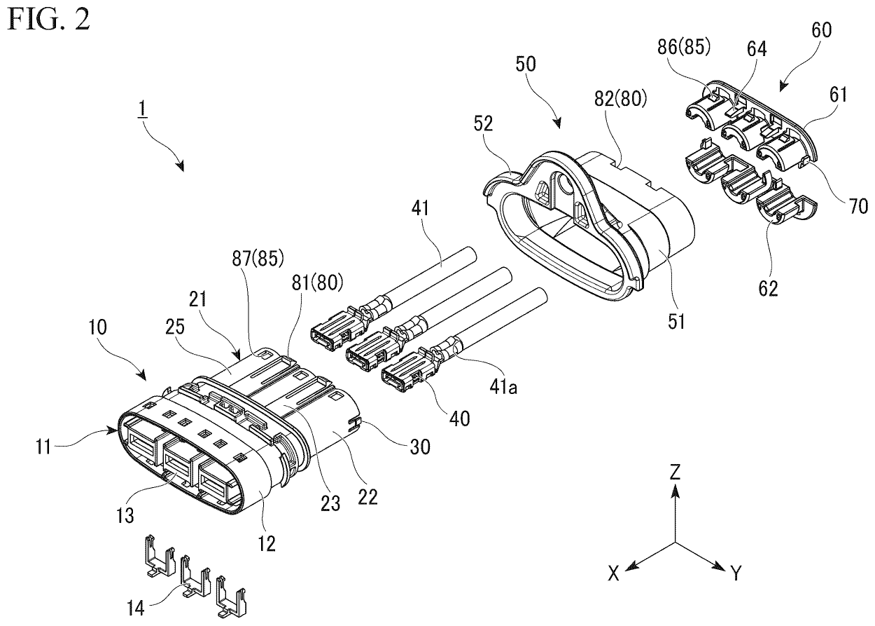

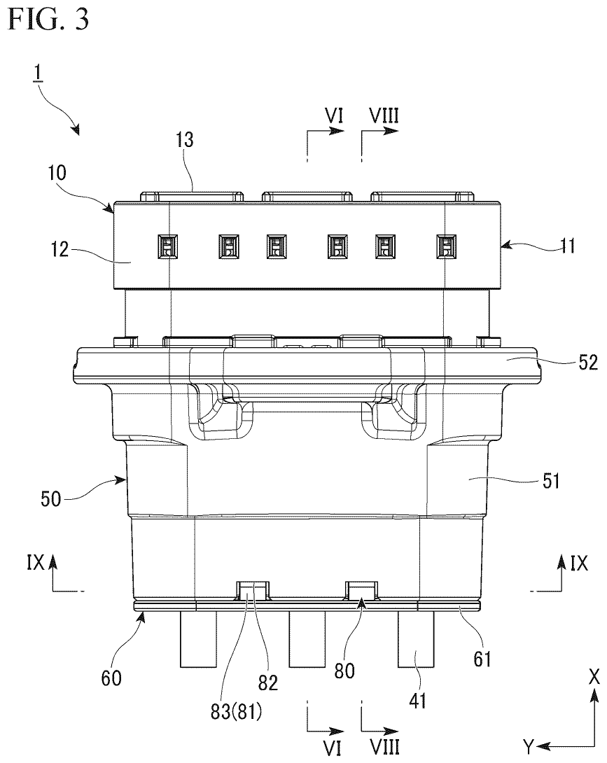

FIG. 1 is a perspective view illustrating the connector 1 of the embodiment. FIG. 2 is an exploded perspective view illustrating the connector 1 of the embodiment. FIG. 3 is a plan view illustrating the connector 1 of the embodiment.

As illustrated in FIGS. 1 to 3, the connector 1 includes a housing 10, the terminal 40, a shell 50, and a rear holder 60. The rear holder 60 is an example of a “holder”.

The housing 10 is a member that is to be coupled to the mating connector. For example, the housing 10 is made of a synthetic resin. The housing 10 has an insulating property. The housing 10 includes a front portion 11 that supports the terminal 40, and an electric wire accommodator 21 through which the electric wire 41 connected to the terminal 40 passes. The front portion 11 is an example of a “terminal support”.

The front portion 11 is a part of the housing 10 that is coupled to the mating connector. The front portion 11 includes a terminal accommodator 13 that accommodates the terminal 40 and a hood 12 that covers the terminal accommodator 13. Note that a shape of the front portion 11 to be described below is an example, and the shape of the front portion is not particularly limited.

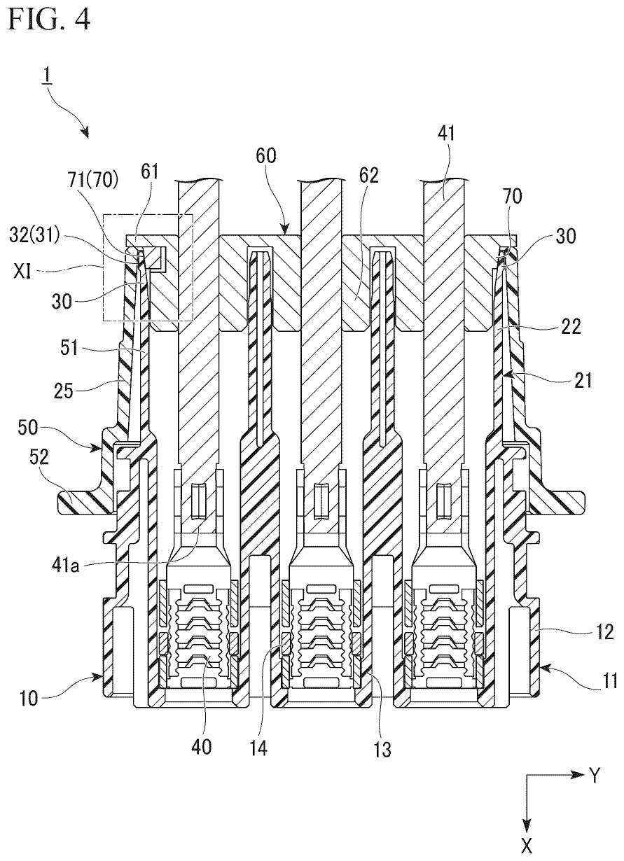

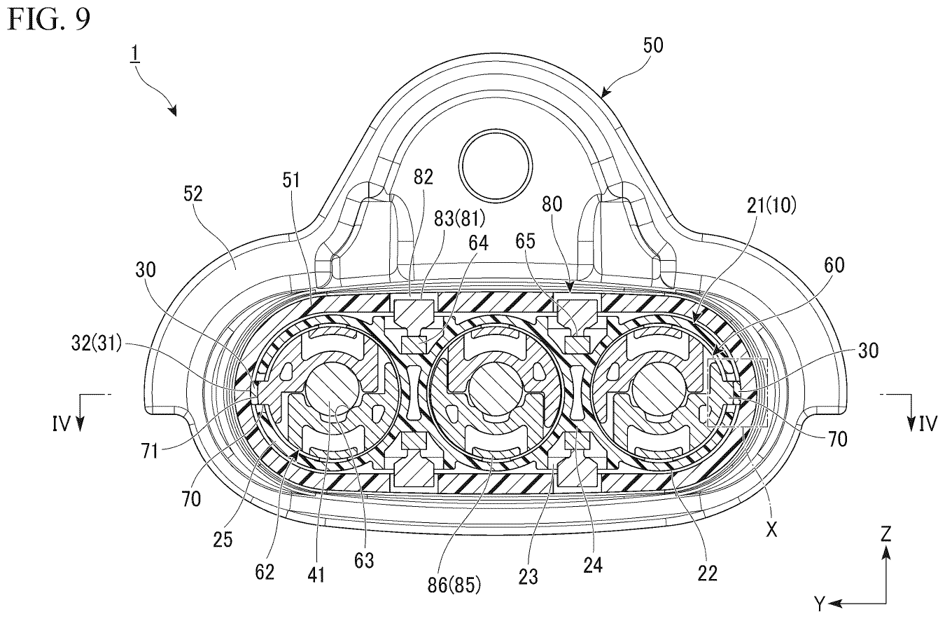

FIG. 4 is a cross-sectional view illustrating the connector 1 of the embodiment and illustrates a cross section at a position taken along line IV-IV in FIG. 9.

As illustrated in FIGS. 2 and 4, the hood 12 is formed in a bottomed cylindrical shape having a circumferential wall portion and a bottom wall portion and is open in the +X direction for connection to the mating connector. The hood 12 has an oval cylinder shape having a major axis along the Y direction. Note that, in the present embodiment, the oval may be read as an ellipse. An annular seal member can be attached to an outer circumference of the hood 12.

The terminal accommodator 13 supports the terminal 40 so that the terminal cannot be relatively displaced. The number of terminal accommodators 13 is the same as the number of terminals 40, and the terminal accommodators 13 hold the terminals 40 in one-to-one. The terminal accommodators 13 are arranged in the Y direction on an inner side of the hood 12. The terminal accommodator 13 has a cylindrical shape extending in the X direction. The terminal accommodator 13 has a quadrangular cylinder shape. The terminal accommodator 13 penetrates a bottom wall of the hood 12. The terminal 40 is disposed in an inside of the terminal accommodator 13. The inside of the terminal accommodator 13 is open in the +X direction for connection of the terminal 40 to the terminal 40 of the mating connector. In addition, the inside of the terminal accommodator 13 is open in the −X direction to pull out the electric wire 41 rearward from the front portion 11. The terminal 40 is inserted into an inner side of the terminal accommodator 13 in the +X direction through the electric wire accommodator 21 in a state of being connected to the electric wire 41. The terminal 40 is locked to the terminal accommodator 13 by a spacer 14. The spacer 14 is disposed to fill gaps in the Y direction between the terminal 40 and side walls of the terminal accommodator 13 on both sides in the Y direction.

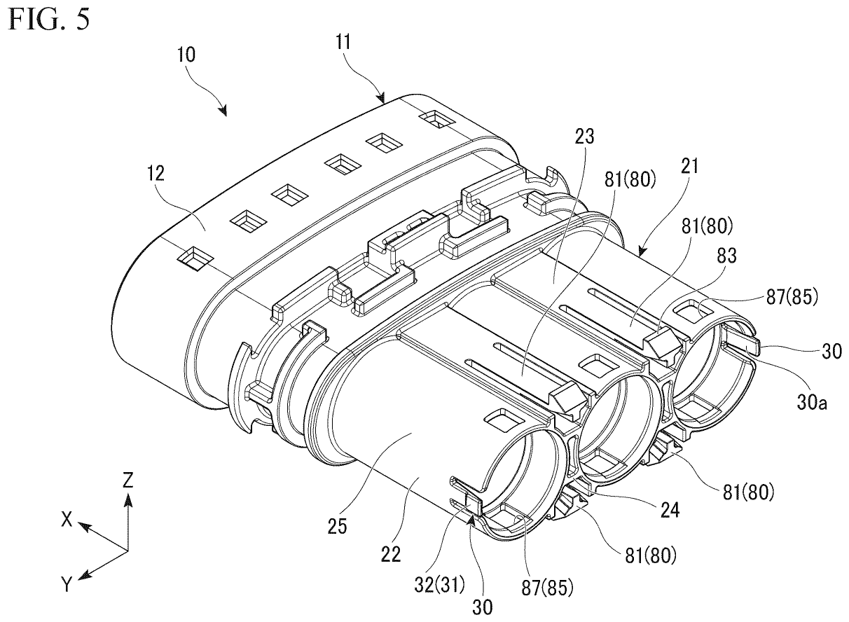

FIG. 5 is a perspective view illustrating the housing 10 of the embodiment.

As illustrated in FIGS. 4 and 5, the electric wire accommodator 21 projects from the front portion 11 in the −X direction. The electric wire accommodator 21 includes a circular cylinder 22, an outer linker 23, and an inner linker 24.

The circular cylinder 22 extends in the X direction. A plurality of (three in the present embodiment) circular cylinders 22 are provided in one-to-one correspondence with the electric wires 41. The plurality of circular cylinders 22 are arranged in the Y direction. The circular cylinder 22 is continuous to an end portion of the terminal accommodator 13 in the −X direction. The inside of the circular cylinder 22 communicates with the inside of the terminal accommodator 13. The electric wire 41 passes through an inner side of the circular cylinder 22. An opening of the circular cylinder 22 in the −X direction is a pull-out port through which the electric wire 41 is pulled out to the outside of the housing 10. When the terminal 40 is assembled to the housing 10, the terminal 40 connected to the electric wire 41 is inserted into the opening of the circular cylinder 22 in the −X direction.

The outer linker 23 is formed in a plate shape extending along an XY plane. The outer linker 23 connects a pair of adjacent circular cylinders 22 to each other. The outer linker 23 is disposed to cover a space between the pair of adjacent circular cylinders 22 from an outer side in the Z direction. That is, two outer linkers 23 are provided for the pair of adjacent circular cylinders 22, and four outer linkers are provided in the present embodiment. The outer linker 23 extends in the −X direction from the bottom wall portion of the hood 12. Side edges of the outer linker 23 on both sides in the Y direction extend in the X direction and are coupled to outer circumferential surfaces of the circular cylinders 22 over the entire length thereof. An end edge of the outer linker 23 in the −X direction extends in the Y direction and is located, in the X direction, at the same position as an end portion of the circular cylinder 22 in the −X direction.

The inner linker 24 connects the pair of adjacent circular cylinders 22 to each other. The inner linker 24 is disposed between the pair of outer linkers 23 adjacent to each other in the Z direction. The two inner linkers 24 are provided for the pair of adjacent circular cylinders 22, and four inner linkers are provided in the present embodiment. The two inner linkers 24 are adjacent to each other at an interval in the Z direction between the pair of adjacent circular cylinders 22. The two inner linkers 24 have gaps in the Z direction from the outer linkers 23. The inner linker 24 extends in the −X direction from the bottom wall portion of the hood 12. Side edges of the inner linker 24 on both sides in the Y direction extend in the X direction and are coupled to outer circumferential surfaces of the circular cylinders 22 over the entire length thereof. An end edge of the inner linker 24 in the −X direction extends in the Y direction and is located, in the X direction, at the same position as the end portion of the outer linker 23 in the −X direction.

As illustrated in FIG. 5, the entire electric wire accommodator 21 is formed in an oval cylinder shape having a major axis along the Y direction. The electric wire accommodator 21 has an outer circumferential wall portion 25 forming an outer circumferential surface of the electric wire accommodator 21. The outer circumferential wall portion 25 is formed by the outer linker 23 and a part of the circular cylinder 22.

As illustrated in FIG. 4, the electric wire 41 has a first end portion 41a that is directly connected to the terminal 40 on an inner side of the housing 10. At the first end portion 41a of the electric wire 41, a core wire of the electric wire 41 is fastened to the terminal 40. The core wire of the electric wire 41 is fastened to the terminal 40 by caulking. However, the core wire of the electric wire 41 may be connected to the terminal 40 by a method other than caulking. The electric wire 41 extends from the first end portion 41a in the −X direction on an inner side of the circular cylinder 22 and is pulled to the outside of the housing 10. A grommet may be attached to the electric wire 41. The grommet is disposed inside the circular cylinder 22. The grommet is in close contact with an outer circumferential surface of the electric wire 41 and an inner circumferential surface of the circular cylinder 22 over the entire circumferences thereof.

The shell 50 is fixed to the housing 10 and is formed to be fixable to the mating connector. The shell 50 is provided to cover the electric wire accommodator 21. The shell 50 is fitted on an outer side of the electric wire accommodator 21 from an opposite side (the −X direction) to the front portion 11. The +X direction is an assembling direction of the shell 50 with respect to the electric wire accommodator 21. The shell 50 includes an enclosure 51 and a flange 52.

The enclosure 51 is disposed over the entire outer circumference of the outer circumferential wall portion 25 of the electric wire accommodator 21. The enclosure 51 is formed in an oval cylinder shape having a major axis along the Y direction corresponding to the shape of the outer circumferential wall portion 25. An inner circumferential surface of the enclosure 51 is close to an outer circumferential surface of the outer circumferential wall portion 25. An end edge of the enclosure 51 in the −X direction is located, in the X direction, at substantially the same position as an end edge of the outer circumferential wall portion 25 in the −X direction. The end edge of the enclosure 51 in the −X direction may be located, in the X direction, at a position in the −X direction from an end edge of the electric wire accommodator 21 in the −X direction. The enclosure 51 is disposed from a periphery of the electric wire accommodator 21 to a periphery of the front portion 11.

As illustrated in FIGS. 2 and 4, the flange 52 protrudes outward along a direction orthogonal to the X direction from an end edge of the enclosure 51 in the +X direction. The flange 52 extends over the entire circumference of the enclosure 51. The flange 52 has a screw hole into which a screw is inserted. The screw is screwed into the mating connector or a member around the mating connector. That is, the flange 52 is fastened to the mating connector or a member around the mating connector.

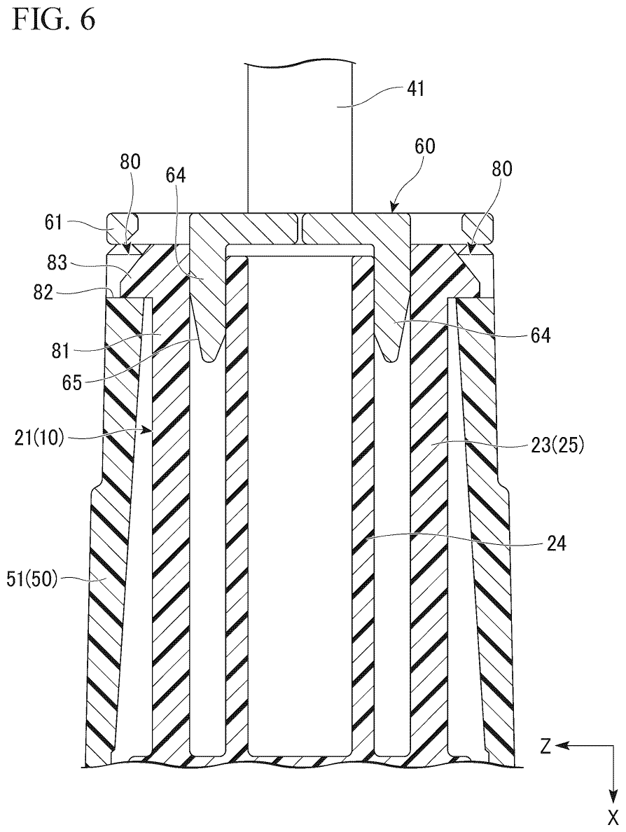

FIG. 6 is a cross-sectional view taken along line VI-VI in FIG. 3.

As illustrated in FIGS. 3 and 6, the shell 50 and the housing 10 include first engagement portions 80 that engage with each other. A plurality of first engagement portions 80 are provided in the Z direction and a plurality of first engagement portions 80 are provided in the Y direction. The first engagement portion 80 includes a first locking lance 81 provided in the housing 10 and a first locking recess 82 provided in the shell 50.

As illustrated in FIG. 5, the first locking lance 81 is provided at the outer circumferential wall portion 25 of the electric wire accommodator 21 of the housing 10. The first locking lance 81 is a portion between a pair of notches extending in the +X direction from an end edge of the outer linker 23 in the −X direction and is formed in a cantilever shape having an end portion in the +X direction as a base end (a fixed end). The first locking lance 81 is formed in a plate shape having a thickness in the Z direction. The first locking lance 81 can be bent in the Z direction. The first locking lance 81 has a first lance projection 83. The first lance projection 83 is provided at a tip end of the first locking lance 81. The first lance projection 83 projects outward from the outer circumferential wall portion 25 toward the enclosure 51 when viewed from the X direction. The first lance projection 83 projects outward in the Z direction from the outer circumferential wall portion 25. The first locking lance 81 is bent in the Z direction, thereby enabling the first lance projection 83 to be elastically displaced inward to be separated from the enclosure 51.

As illustrated in FIGS. 3 and 6, the first locking recess 82 is provided in the enclosure 51 of the shell 50. The first locking recess 82 is open in the inner circumferential surface of the enclosure 51. The first locking recess 82 is formed at a position opposite to the first lance projection 83 in the inner circumferential surface of the enclosure 51. In the present embodiment, the first locking recess 82 penetrates the enclosure 51 in a thickness direction of the enclosure 51 and is open at the end edge of the enclosure 51 in the −X direction. In a completely fitted state of the housing 10 and the shell 50, the first lance projection 83 enters the first locking recess 82. An opening edge of the first locking recess 82 engages with the first lance projection 83 from the +X direction, thereby restricting the shell 50 from moving in the −X direction with respect to the housing 10.

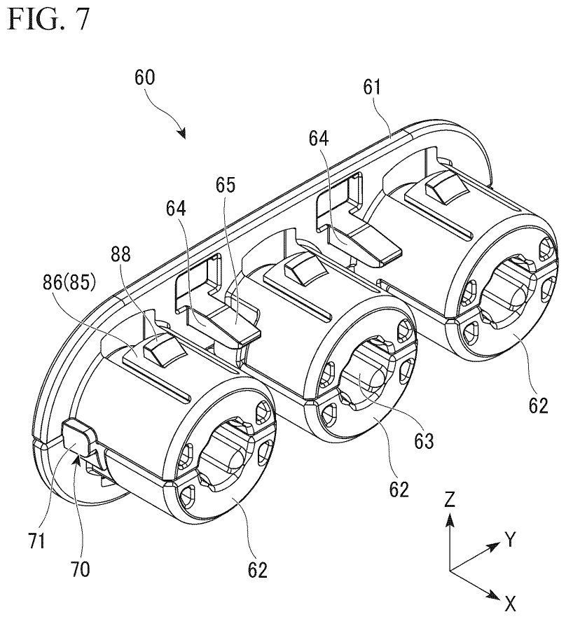

FIG. 7 is a perspective view illustrating a rear holder 60 of the embodiment.

As illustrated in FIGS. 4 and 7, the rear holder 60 holds the flexible electric wire 41. The rear holder 60 is disposed in the housing 10 and the shell 50 so as not to be relatively displaced. The rear holder 60 is fitted in an inner side of the electric wire accommodator 21 and directly fixed to the housing 10. The rear holder 60 includes a blocker 61 and an insertion portion 62.

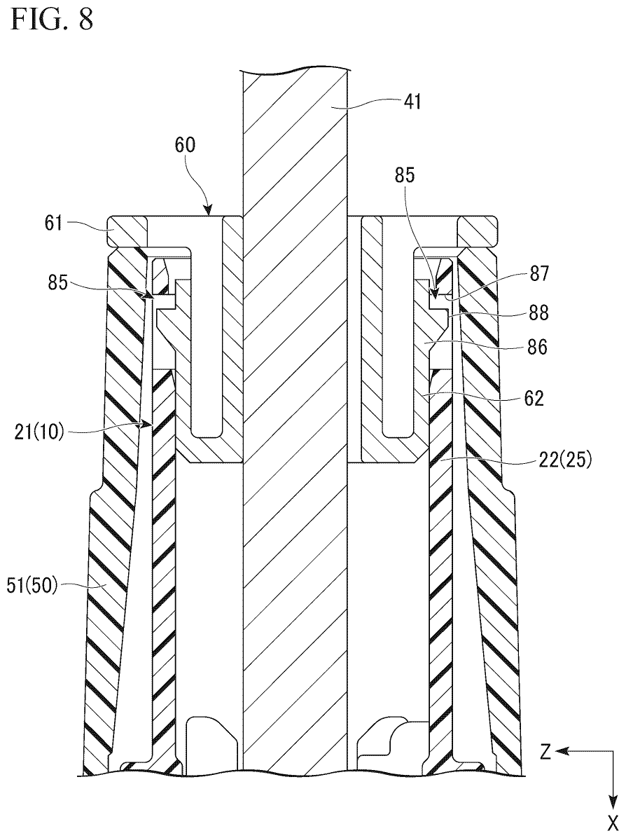

FIG. 8 is a cross-sectional view taken along line VIII-VIII in FIG. 3.

As illustrated in FIGS. 4 and 8, the blocker 61 is formed to cover the entire end portion of the electric wire accommodator 21 in the −X direction and the entire end portion of the enclosure 51 of the shell 50 in −X direction. The blocker 61 is formed in an oval plate shape having a major axis along the Y direction when viewed from the X direction, corresponding to a shape of an opening edge of the enclosure 51 in the −X direction (an end edge in the −X direction) (see FIG. 7). An outer circumferential portion of the blocker 61 faces the opening edge of the enclosure 51 in the −X direction over the entire circumference (see FIG. 3). The outer circumferential portion of the blocker 61 is adjacent to the opening edge of the enclosure 51 in the −X direction with substantially no gap therebetween. However, the outer circumferential portion of the blocker 61 may be close to the opening edge of the enclosure 51 in the −X direction with a slight gap. The blocker 61 is adjacent to the opening edge of the enclosure 51 in the −X direction with substantially no gap, thereby enabling that the rear holder 60 is disposed at a normal position with respect to the shell 50 and the housing 10 to be identified from outside.

As illustrated in FIGS. 4 and 7, the insertion portion 62 is inserted into an inner side of the circular cylinder 22 of the electric wire accommodator 21 from the opposite side to the front portion 11. The number of insertion portions 62 is the same as the number of circular cylinders 22, and the insertion portions are inserted into the inner side of the circular cylinders 22 one by one. The insertion portion 62 is formed in a circular cylinder shape extending in the X direction corresponding to an inner shape of the circular cylinder 22.

FIG. 9 is a cross-sectional view taken along line IX-IX in FIG. 3.

As illustrated in FIG. 9, a protrusion 63 is formed on an inner circumferential surface of the insertion portion 62. The electric wire 41 passes through an inner side of the insertion portion 62. The protrusion 63 is embedded in a sheath of the electric wire 41, thereby causing the insertion portion 62 to hold the electric wire 41 so as not to be displaced.

As illustrated in FIGS. 6 and 7, the rear holder 60 includes a restrictor 64 that restricts displacement of the first lance projection 83. The restrictor 64 projects in the +X direction from the blocker 61 toward an inside of the outer circumferential wall portion 25. The restrictors 64 are provided in one-to-one correspondence with the first lance projections 83. The restrictor 64 is disposed inside the first locking lance 81. The restrictor 64 is inserted between the first locking lance 81 and the inner linker 24. The restrictor 64 is in direct contact with the inner linker 24 and is restricted from being displaced to a side (inward) away from the first locking lance 81. The restrictor 64 is in direct contact with the first locking lance 81 and restricts displacement of the first locking lance 81 in a direction (inward) away from the enclosure 51. A tip end portion of the restrictor 64 tapers such that a thickness thereof in the Z direction decreases toward the +X direction. The tip end portion of the restrictor 64 has, toward the −X direction, a sliding surface 65 extending toward the enclosure 51 (outward in the Z direction) when viewed from the X direction. In a process of inserting the insertion portion 62 into the inner side of the circular cylinder 22, the tip end of the first locking lance 81 slides on the sliding surface 65 and is pressed toward the enclosure 51 (outward in the Z direction).

Note that, in a half-fitted state of the housing 10 and the shell 50, the tip end of the first locking lance 81 is located on the inner side deeper than a normal position, and the tip end portion of the restrictor 64 abuts on the tip end of the first locking lance 81 in the process of inserting the insertion portion 62 into the circular cylinder 22. The tip end portion of the restrictor 64 abuts the tip end of the first locking lance 81, thereby restricting insertion of the insertion portion 62 into the circular cylinder 22. In the half-fitted state of the housing 10 and the shell 50, the insertion of the insertion portion 62 into the circular cylinder 22 is restricted in a state in which the rear holder 60 is located at a position in the −X direction from a normal position with respect to the shell 50 and the housing 10.

As illustrated in FIGS. 5, 7, and 8, the housing 10 and the rear holder 60 include second engagement portions 85 that engage with each other. A plurality of the second engagement portions 85 are provided in the Z direction and, a plurality of the second engagement portions 85 are provided in the Y direction. The second engagement portion 85 includes a second locking lance 86 provided in the rear holder 60 and a second locking recess 87 provided in the housing 10.

As illustrated in FIGS. 7 and 8, the second locking lances 86 are provided at the insertion portions 62. The second locking lances 86 are provided at end portions of the insertion portions 62 in the +Z direction and in the −Z direction. The second locking lance 86 has a cantilever shape with an end portion in the +X direction as a base end (a fixed end). The second locking lance 86 is connected to an opening edge of a recess formed in an outer circumferential surface of the insertion portion 62. The second locking lance 86 is formed in a plate shape having a thickness in the Z direction. The second locking lance 86 can be bent in the Z direction. The second locking lance 86 has a second lance projection 88. The second lance projection 88 projects outward from the outer circumferential surface of the insertion portion 62 toward the circular cylinder 22 when viewed from the X direction. The second lance projection 88 projects outward in the Z direction from the outer circumferential surface of the insertion portion 62. The second locking lance 86 is bent in the Z direction, thereby enabling the second lance projection 88 to be elastically displaced inward to be separated from the circular cylinder 22.

As illustrated in FIGS. 5 and 8, the second locking recess 87 is provided in the outer circumferential wall portion 25 of the electric wire accommodator 21 of the housing 10. The second locking recess 87 is open in the inner circumferential surface of each circular cylinder 22. The second locking recess 87 is formed at a position opposite to the second lance projection 88 in the inner circumferential surface of the circular cylinder 22. In the present embodiment, the second locking recess 87 penetrates the circular cylinder 22 in a radial direction of the circular cylinder 22. In the completely fitted state of the housing 10 and the rear holder 60, the second lance projection 88 enters the second locking recess 87. An opening edge of the second locking recess 87 engages with the second lance projection 88 from the −X direction, thereby restricting movement of the rear holder 60 in the −X direction with respect to the housing 10.

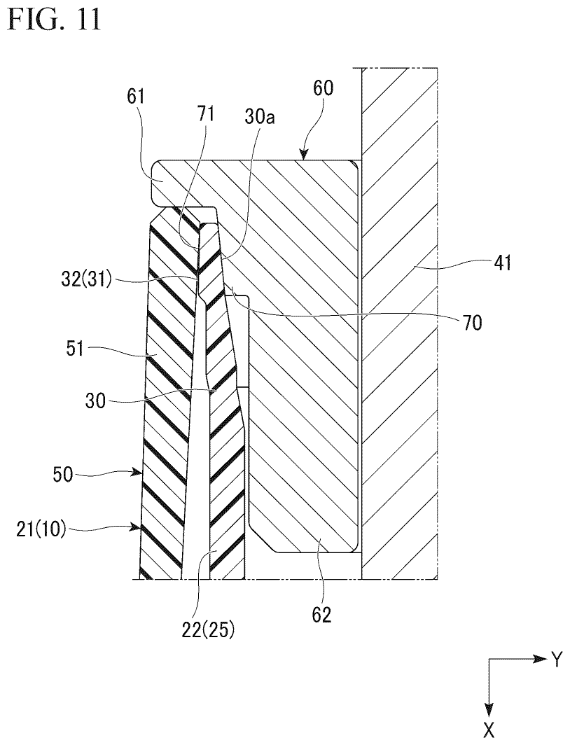

As illustrated in FIG. 5, the housing 10 includes a press-fitting arm 30 provided along the inner circumferential surface of the enclosure 51 of the shell 50. The press-fitting arm 30 is an example of a “press-fitter”. The press-fitting arms 30 are arranged in a direction orthogonal to the X direction. In the present embodiment, the press-fitting arms 30 are arranged in the Y direction and are provided at both end portions of the outer circumferential wall portion 25 in the Y direction. A pair of press-fitting arms 30 arranged in the Y direction is an example of a “first press-fitter” and a “second press-fitter”. The press-fitting arm 30 is provided in the circular cylinder 22. The press-fitting arm 30 is a portion between a pair of notches extending in the +X direction from an end edge of the circular cylinder 22 in the −X direction and has a cantilever shape having a free end on the opposite side to the front portion 11 (in the −X direction). The press-fitting arm 30 extends along the X direction with a constant width. The press-fitting arm 30 is formed in a plate shape having a thickness in the Y direction. The press-fitting arm 30 can be bent in the Y direction. The press-fitting arm 30 has a sliding allowing surface 30a facing an inner side of the outer circumferential wall portion 25. The sliding allowing surface 30a extends inward (inward in the Y direction) when viewed from the X direction toward the +X direction to face an opening side of the outer circumferential wall portion 25 in the −X direction (see FIG. 11).

The press-fitting arm 30 includes a press-fitting protrusion 31. The press-fitting protrusion 31 bulges toward the enclosure 51 (outward in the Y direction) when viewed from the X direction. The press-fitting protrusion 31 is provided at an interval in the X direction with respect to the base end (a fixed end) of the press-fitting arm 30. The press-fitting protrusion 31 is provided at a tip end of the press-fitting arm 30. The press-fitting protrusion 31 is positioned at the end portion of the circular cylinder 22 in the −X direction. A top surface 32 of the press-fitting protrusion 31 has a rectangular shape.

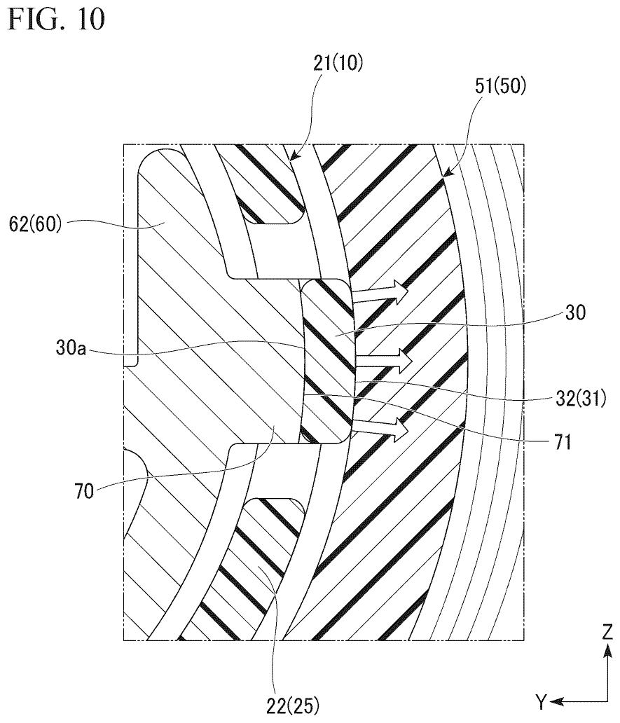

FIG. 10 is an enlarged view of portion X in FIG. 9.

As illustrated in FIG. 10, the top surface 32 of the press-fitting protrusion 31 is in contact with the inner circumferential surface of the enclosure 51. The top surface 32 of the press-fitting protrusion 31 is formed in a convex curved surface shape. The top surface 32 of the press-fitting protrusion 31 extends parallel to an inner circumferential surface of a position of the enclosure 51 which faces the press-fitting protrusion 31 when viewed from the X direction. In the present embodiment, the top surface 32 of the press-fitting protrusion 31 is a circular cylindrical surface extending in the X direction. The top surface 32 of the press-fitting protrusion 31 is in contact with the inner circumferential surface of the enclosure 51 at a plurality of positions when viewed from the X direction. In the present embodiment, the top surface 32 of the press-fitting protrusion 31 is in contact with the inner circumferential surface of the enclosure 51 over the entire length of the top surface 32 when viewed from the X direction. The press-fitting protrusion 31 is in contact with the inner circumferential surface of the enclosure 51 at the plurality of positions facing different directions, thereby causing the press-fitting protrusion 31 to be in pressure contact with the enclosure 51 in a plurality of directions which are not parallel to each other as represented by arrows in FIG. 10. Note that, in the present embodiment, the top surface 32 of the press-fitting protrusion 31 is not in contact with an inner surface of the enclosure 51 in a state in which a pressurizer 70 to be described below is not in contact with the press-fitting arm 30.

As illustrated in FIGS. 7 and 9, the rear holder 60 includes the pressurizer 70 that pressurizes the press-fitting arm 30 toward the inner circumferential surface of the enclosure 51. A plurality of (two in the present embodiment) pressurizers 70 are provided in one-to-one correspondence with the press-fitting arms 30. The pressurizer 70 is disposed inside the press-fitting arm 30 and faces the press-fitting arm 30. The pressurizers 70 are provided at both end portions of the rear holder 60 in the Y direction. Of the plurality of insertion portions 62, the pressurizer 70 is formed integrally with the insertion portion 62 positioned at both ends in the Y direction. The pressurizer 70 projects from the outer circumferential surface of the insertion portion 62 toward the press-fitting arm 30. The pressurizer 70 is continuous to the blocker 61.

FIG. 11 is an enlarged view of portion XI in FIG. 4.

As illustrated in FIG. 11, the pressurizer 70 is in contact with the press-fitting arm 30. The pressurizer 70 has a top surface 71 that is in contact with the sliding allowing surface 30a of the press-fitting arm 30. The top surface 71 of the pressurizer 70 is in contact with a position of the sliding allowing surface 30a which is located a back side of the press-fitting protrusion 31. The top surface 71 of the pressurizer 70 extends outward (outward in the Y direction) toward the −X direction when viewed from the X direction to face the +X direction. In the process of inserting the insertion portion 62 into the circular cylinder 22, the pressurizer 70 is also inserted into the inner side of the circular cylinder 22 from the opposite side to the front portion 11. When the pressurizer 70 is inserted into the inner side of the circular cylinder 22, the pressurizer 70 slides on the sliding allowing surface 30a of the press-fitting arm 30. The press-fitting arm 30 is pressed toward the enclosure 51 (outward in the Y direction) by the pressurizer 70. The press-fitting arm 30 is pressed by the pressurizer 70, thereby being bent outward in the Y direction toward the enclosure 51. The top surface 32 of the press-fitting protrusion 31 comes into pressure contact with the inner circumferential surface of the enclosure 51 in a state in which the press-fitting arm 30 is bent. In this manner, the press-fitting arm 30 is press-fitted between the enclosure 51 and the insertion portion 62 of the rear holder 60.

As illustrated in FIGS. 2 and 9, the rear holder 60 is formed by combining two parts to sandwich the electric wire 41 from both sides in the Z direction. In other words, the rear holder 60 is formed to be dividable into two parts. The two parts forming the rear holder 60 are formed to collectively sandwich all the electric wires 41 arranged in the Y direction from both sides in the Z direction. The rear holder 60 holds the electric wires 41 by sandwiching the electric wires 41 between the two parts. The top surface 71 of the pressurizer 70 is formed as a single part so as not to be formed across the two parts. In the present embodiment, the pressurizer 70 itself is formed of a single part.

More specifically, one pressurizer 70 is formed for one of the two parts forming the rear holder 60, and the other pressurizer 70 is formed for the other part.

In the present embodiment, the electric wire accommodator 21 of the housing 10 includes the press-fitting arm 30 press-fitted between the shell 50 and the rear holder 60. According to this configuration, it is possible to avoid rattling between the housing 10 and the shell 50 and between the housing 10 and the rear holder 60. Therefore, the electric wires 41 held by the rear holder 60 are fixed to the shell 50 and the housing 10. Hence, it is possible to prevent such a matter as vibration of the electric wires 41 being transmitted to the terminals 40 without being restrained by the rear holder 60.

The press-fitting arm 30 has a cantilever shape provided along an inner surface of the shell 50. The rear holder 60 includes the pressurizer 70 that pressurizes the press-fitting arm 30 toward the inner surface of the shell 50. According to such a configuration, the press-fitting arm 30 is easily bent toward the inner surface of the shell 50. The rear holder 60 is fitted in an inner side of the electric wire accommodator 21, thereby causing the press-fitting arm 30 to be pressurized by the pressurizer 70 and bent toward the inner surface of the shell 50 and to be pressed against the inner surface of the shell 50. Therefore, the press-fitting arm 30 is press-fitted between the shell 50 and the pressurizer 70 of the rear holder 60. Hence, an example of a configuration that achieves the above-described operation and effects can be obtained.

The electric wire accommodator 21 is formed in a cylindrical shape extending in the X direction. The pressurizer 70 is inserted into an inner side of the electric wire accommodator 21 from the opposite side to the front portion 11. The press-fitting arm 30 extends along the X direction and has, as a free end, an end portion on an opposite side to an end portion on the front portion 11 side. According to such a configuration, since the free end of the press-fitting arm 30 is positioned on the opposite side to the front portion 11, the free end is disposed at a position closer to the pressurizer 70 than the fixed end is. Therefore, as compared with the configuration in which a free end of a press-fitting arm is positioned on the front portion 11 side, the press-fitting arm 30 can be easily bent by being pressurized by the pressurizer 70. Hence, the press-fitting arm 30 can be reliably pressed against the inner surface of the shell 50, and a state in which the press-fitting arm 30 is press-fitted between the shell 50 and the pressurizer 70 of the rear holder 60 can be reliably realized.

The pair of press-fitting arms 30 are arranged in the Y direction orthogonal to the X direction which is the assembling direction of the shell 50 with respect to the electric wire accommodator 21. According to such a configuration, it is possible to suppress relative displacement of the housing 10, the shell 50, and the rear holder 60 in both the +Y direction and the −Y direction. Hence, rattling between the housing 10 and the shell 50 and between the housing 10 and the rear holder 60 can be more reliably avoided.

The press-fitting arm 30 is in pressure contact with the shell 50 in a plurality of directions. According to such a configuration, the relative displacement of the housing 10 and the shell 50 in a plurality of directions can be restricted by the press-fitting arm 30 at one position. Therefore, the housing 10 and the shell 50 can be reliably fixed in a plurality of directions.

In the above-described embodiment, the press-fitting arm 30 has the press-fitting protrusion 31. However, the press-fitting arm may not have the press-fitting protrusion.

In the above-described embodiment, the housing 10 is formed to allow the electric wire 41 to be pulled out in the −X direction. However, the housing may be formed to allow the electric wire to be pulled out in a direction intersecting the X direction. That is, the electric wire accommodator of the housing may not be provided behind (in the −X direction of) the terminal support that supports the terminal.

In the above-described embodiment, the pair of press-fitting arms 30 are arranged in the Y direction. However, if the press-fitting arms are arranged in a direction intersecting the X direction, the above-described operation and effects are obtained. In addition, the housing may have a single press-fitting arm, and the rear holder may have a single pressurizer.

Several embodiments and modification examples have been described above. However, the embodiments and the modification examples are not limited to the examples described above. For example, a plurality of embodiments may be realized in combination with each other. The above-described embodiments can be implemented in various other forms, and various additions, omissions, substitutions, and modifications can be performed without departing from the gist of the disclosure.

### INDUSTRIAL APPLICABILITY

According to the disclosure, transmission of vibration from an electric wire to a terminal can be suppressed.

### REFERENCE SIGNS LIST

1 connector
10 housing
11 front portion (terminal support)
21 electric wire accommodator
30 press-fitting arm (press-fitter, first press-fitter, second press-fitter)
40 terminal
41 electric wire
50 shell
60 rear holder (holder)
70 pressurizer

What is claimed is:

1. A connector comprising:
a housing having a terminal support that supports a terminal, and an electric wire accommodator through which an electric wire connected to the terminal passes;
a shell fitted on an outer side of the electric wire accommodator from an opposite side of the terminal support; and
a holder that holds the electric wire and is fitted in an inner side of the electric wire accommodator;
wherein the electric wire accommodator includes a press-fitter that is press-fitted between the shell and the holder.

2. The connector according to claim 1, wherein
the press-fitter has a cantilever shape provided along an inner surface of the shell, and
the holder includes a pressurizer that pressurizes the press-fitter toward the inner surface of the shell.

3. The connector according to claim 2, wherein
the electric wire accommodator is formed in a cylindrical shape extending in a first direction,
the pressurizer is inserted into an inner side of the electric wire accommodator from an opposite side of the terminal support, and
the press-fitter extends along the first direction and has, as a free end, an end portion on a side opposite to an end portion on the terminal support side.

4. The connector according to claim 1, wherein
the press-fitter has a first press-fitter and a second press-fitter, and
the first press-fitter and the second press-fitter are arranged in a direction orthogonal to an assembling direction of the shell with respect to the electric wire accommodator.

5. The connector according to claim 1, wherein the press-fitter is in pressure contact with the shell in a plurality of directions.
